(19) United States
(12) Patent Application Publication
(10) Pub. No.: US 2006/0016340 A1
(43) Pub. Date: Jan. 26, 2006

(54) Filter system

(75) Inventors: Volker Braeunling, Heppenheim (DE); Ulrich Stahl, Laudenbach (DE); Uwe Felber, Absteinach (DE); Heiko Schacht, Hirschberg (DE); Robert Bader, Heidelberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/184,092

(22) Filed: Jul. 19, 2005

(30) Foreign Application Priority Data
Jul. 23, 2004 (DE) 10 2004 035 967.9

(51) Int. Cl. B01D 53/02

(52) U.S. Cl. 96/134

(57) ABSTRACT

A filter system in particular for filtering the fresh air supplied to the interior of a motor vehicle is described, including at least one particle-filtering area and at least one chemical filter area, the chemical filter area including an activated carbon filter. The particle-filtering area has a filter efficiency of T (0.3 μm)≧90%, measured according to DIN 71460/1 @ 300 m³/h using AC fine test dust and T (0.1 μm)≧60%, measured according to DIN 71460 @ 300 m³/h using NaCl as the test aerosol. The filter system is characterized by an optimized separation of diesel exhaust and in particular by a definitely improved odor reduction in the case of diesel odor.

Priority is claimed to German Patent Application No. DE 10 2004 035 967.9, filed on Jul. 23, 2004, the entire disclosure of which is incorporated by reference herein.

### FIELD OF THE INVENTION

The present invention relates to a filter system, in particular for filtering the incoming air for the interior of an automobile.

### BACKGROUND

The odor of diesel is known as a characteristic “nuisance odor” in automotive filter applications, in particular in filtering the fresh air supplied to the interior of a motor vehicle. Although the diesel odor is discernible even in extremely low concentrations and is perceived as extremely unpleasant, the filters and filter systems conventionally used today in the automotive field for filtering the fresh air for the interior of a vehicle are still inadequate with regard to filtering diesel odor.

### SUMMARY OF THE INVENTION

The object of the present invention is to provide a filter which is optimized with regard to the separation of diesel exhaust and yields in particular a substantial reduction in diesel odor.

This object is achieved by a filter system having at least one particle-filtering area and at least one chemical filter area, the chemical filter area including an activated carbon filter, wherein the particle-filtering area has a filter efficiency of T (0.3 μm)≧90%, when measured according to DIN 71460/1 @ 300 m³/h using AC fine test dust, and of T (0.1 μm)≧60%, measured according to DIN 71460 @ 300 m³/h using NaCl as the test aerosol.

According to the present invention, in the case of a filter system that is usable in particular for filtering the fresh air for the interior of a motor vehicle and which includes at least one particle-filtering area and at least one chemical filter area, the chemical filter area including an activated carbon filter, the particle-filtering area is designed to have an initial (i.e., first-use) filter efficiency of T (0.3 μm)≧90%, measured according to DIN 71460/1 @ 300 m³/h using AC fine test dust and T (0.1 μm)≧60%, measured according to DIN 71460 @ 300 m³/h using NaCl as the test aerosol. It has surprisingly been found that evidently not only the gaseous diesel exhaust but also the submicron particles in diesel exhaust (<2.5 μm; airborne diesel soot particles have their number distribution maximum at approx. 0.1-0.3 μm) function as odor carriers, so that an improvement in separation efficiency of a filter with respect to these particles in combination with an essentially known activated carbon filter such as that proposed according to the present invention yields a greatly improved reduction in diesel odor in comparison with known filters and/or filter systems.

The odor reduction is further improved by chemically impregnating the activated carbon of the activated carbon filter in an essentially known manner to eliminate acidic gases. It has been found that the acidic gases present in diesel exhaust are responsible to a great extent for the strong odor produced. Suitable substances and methods for impregnating the activated carbon to eliminate acidic gases are known in the related art and therefore will not be discussed further here. In addition, the filter system according to the present invention may also have activated carbon filter areas having catalytic and/or basic properties.

The filter system according to the present invention is advantageously designed as a combination filter. This is understood to refer to filter systems in which the filter material is composed of at least one particle-filtering layer and at least one layer of a chemical filter material, e.g., activated carbon.

In a preferred embodiment of the present invention, the particle-filtering area and/or the chemical filter area is/are designed as a nonwoven filter. An improvement in the separation of soot particles from diesel exhaust is easily achieved by having the particle filter material include microfibers, although the use of microfibers is not obligatory for the desired effect.

A further improvement in the separation of soot particles from diesel exhaust is also achievable by a nonwoven that includes areas having an electrostatic charge in an essentially known manner.

In addition to the particle-filtering area and the activated carbon filter area, a filter system according to the present invention may also include other filter areas which may be specialized in removing certain pollutants from diesel exhaust, for example. For example, the particle-filtering area may include multiple layers that filter different particle sizes. The transition between these areas may be designed as discontinuous or continuous. In addition to the activated carbon filter area, other areas that enter into chemical reactions with certain types of gaseous pollutants may also be provided.

A filter system according to the present invention is preferably used for filtering the incoming air for the interior of motor vehicles. In addition, however, use in air conditioning equipment is also conceivable, with both mobile and stationary applications being feasible. Another preferred area of use for filtering air in spaces in which diesel vehicles, e.g., forklifts, are used. However, the present invention is not limited to these areas of application.

### BRIEF DESCRIPTION OF THE DRAWINGS

FIG. 1 shows a graph of odor measurements comparing filters according to embodiments of the present invention to a conventional filter and to crude diesel exhaust.

FIG. 2 shows a graph of the separation of diesel soot particles from diesel exhaust for filters according to embodiments of the present invention and for conventional filters.

### DETAILED DESCRIPTION

Several different filter designs for filter systems according to the present invention which include at least one particle-filtering area and at least one chemical filter area, the chemical filter area including an activated carbon filter, wherein the particle-filtering area has a filter efficiency of T (0.3 μm)≧90%, when measured according to DIN 71460/1 @ 300 m³/h using AC fine test dust, and of T (0.1 μm)≧60%, measured according to DIN 71460 @ 300 m³/h using NaCl as the test aerosol are described below. It is thereby apparent that a filter system according to the present invention may be implemented in a wide variety of ways. This is a combination filter made of a nonwoven material, without any restriction on the general scope of the present invention.

The activated carbon filter area may have the following structure:

Granular activated carbon (20×150 mesh) or spherical activated carbon or flat sheeting (either woven or knit cloth) of activated carbon fibers having a weight per unit area of 150 to 450 g/m², impregnated or not impregnated against acidic and/or basic gases on a carrier of PP (polypropylene) or PES (polyester) having a weight per unit of area of 20-60 g/m².

The particle-filtering area may have the following structure:
a) two or three layers having a prefilter of a polyolefin or PES with/without an electrostatic charge and having a weight per unit of area of 40-120 g/m² and a fiber diameter of 20-50 μm; another filter layer of polyolefin or PC (polycarbonate) microfibers having an electrostatic charge, a weight per unit of area of 5-30 g/m² and a fiber diameter of 1-10 μm;and optionally having a polyolefin or PES cover layer with/without an electrostatic charge, a weight per unit of area of 10-50 g/m² and a fiber diameter of 20-50 μm, or
b) two or three layers having a backing of polyolefin or PES with/without an electrostatic charge, a weight per unit of area of 40-180 g/m² and a fiber diameter of 20-50 μm, another filter layer of a polyolefin/polyacrylonitrile fiber blend, triboelectrically charged, having a weight per unit of area of 10-100 g/m² and a fiber diameter of 5-30 μm; and optionally having a cover layer of a polyolefin or PES with/without an electrostatic charge, having a weight per unit of area of 10-50 g/m² and a fiber diameter of 20-50 μm, or
c) one layer having a filter layer of a polyolefin/polyacrylonitrile fiber blend, triboelectrically charged and having a weight per unit of area of 10-150 g/m² and a fiber diameter of 5-30 μm, or
d) one layer having a filter layer of PES, with/without an electrostatic charge, having a weight per unit of area of 40-180 g/m² and a fiber diameter of 20-50 μm, or
e) one layer having a filter layer of polyolefin, PES or PC microfibers having a weight per unit of area of 5-30 g/m² and a fiber diameter of 1-10 μm.

### EXAMPLES

Comparative measurements were performed on a combination filter (“diesel filter”) designed according to the present invention and on a conventional commercial standard combination filter to detect the effect according to the present invention.

In a first measurement, the diesel odor was determined for a system without a filter (“diesel crude gas sample”), for the above-mentioned standard combination filter (“standard filter”), and for the combination filter (“diesel filter”) designed according to the present invention. For comparison purposes, the diesel odor for a particle filter alone (“only high efficiency particle filter”), corresponding in design to the particle-filtering area of the combination filter according to the present invention as mentioned above, was also determined. The odor was measured according to DIN 13725. The measurement samples were obtained as follows: a circle having a 60 mm diameter was punched out of each filter element. The circle was then placed in a glass frit and sealed at the edges. Then the crude gas sample was drawn through the glass frit and through the filter medium into a bag. Flow rates of approx. 0.1 m/s were established in this way. These flow rates are approximately comparable to the flow rates that prevail in a fan unit in a motor vehicle. The odor measurement was then performed by an olfactometric test stand conforming to the DIN EN 13725 standard.

Diesel exhaust from a conventional modern turbo-diesel engine, displacement 1.9 L, in idling operation at normal operating temperature (reached after operating for about 10 minutes) was used as the measurement aerosol.

The combination filter (“diesel filter”) according to the present invention and/or the “high efficiency particle filter” were designed as follows:

With both filters, a three-layer particle filter according to exemplary embodiment a) was used. The particle filter had a prefilter of PP having an electrostatic charge, a weight per unit of area of 115 g/m² and a fiber diameter of approx. 40 μm. Another filter layer included PP microfibers having an electrostatic charge, a weight per unit of area of 20 g/m² and a fiber diameter of approx. 5 μm. The cover layer was made of PP having an electrostatic charge, a weight per unit of area of 15 g/m² and a fiber diameter of 30 μm.

In the case of the combination filter (“diesel filter”) according to the present invention, granular activated carbon (30×60 mesh) was again used for the chemical filter area; this activated carbon has a weight per unit of area of 350 g/m², was impregnated against acidic gases and applied to a backing of PES having a weight per unit of area of 50 g/m².

The standard filter was designed as follows: one-layer particle filter having a filter layer of polypropylene (PP) having an electrostatic charge, a weight per unit of area of 60 g/m² and a fiber diameter of approx. 30 μm. The particle filter was combined with a chemical filter layer. This chemical filter layer containing granular, unimpregnated activated carbon (30×60 mesh) having a weight per unit of area of 350 g/m² was applied to a backing of PES having a weight per unit of area of approx. 50 g/m².

In another measurement, the separation of diesel particles by the combination filter (diesel filter) according to the present invention was compared with that of a standard filter. The measurements were performed according to DIN 71460/1 @ 300 m³/h using AC fine test dust and according to DIN 71460 @ 300 m³/h using NaCl test aerosol.

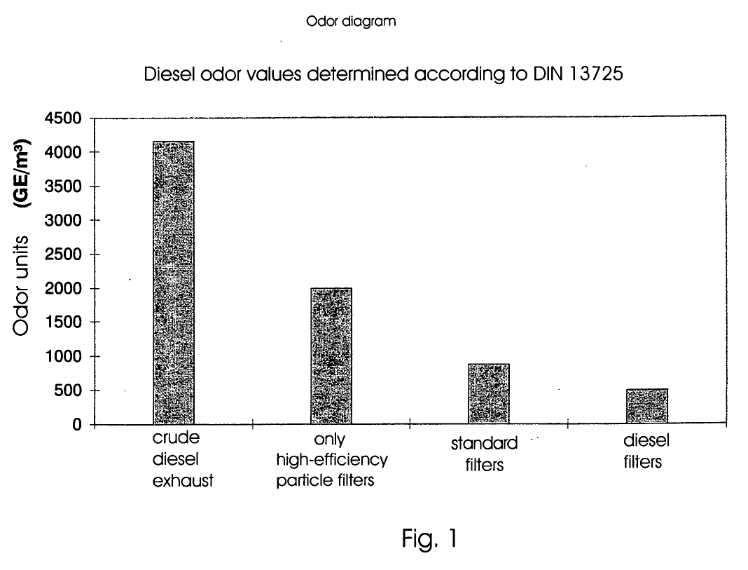

FIG. 1 shows the results of the odor measurement on a sample of crude diesel exhaust, the above-mentioned high efficiency particle filter alone, the standard filter and the combination filter (diesel filter) according to the present invention. The odor values are represented in units of GE (European odor units)/m³, where GE (European odor unit) is defined according to DIN EN 13725, section 3.3.

It is apparent here that the particle filter alone produces a significant reduction in odor in comparison with the system without a filter (crude sample of diesel exhaust). This is confirmed by the assumption resulting from the present invention, namely that diesel soot particles also function as odor carriers. When using the standard filter, there is a definite reduction in odor. The best values are obtained with the combination filter (diesel filter) according to the present invention.

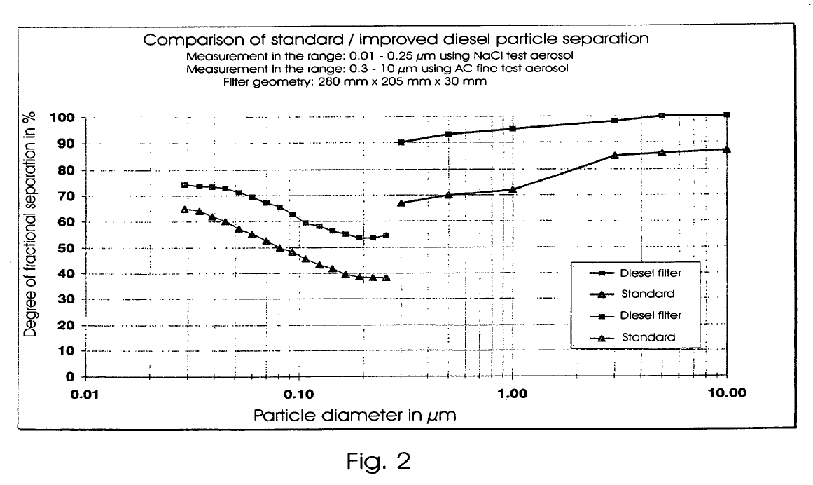

FIG. 2 shows the plot of the degree of fractional separation in percent as a function of particle diameter for both the combination filter (diesel filter) according to the present invention and the standard filter. Here again, a definite superiority of the combination filter (diesel filter) according to the present invention is discernible in comparison with the traditional standard filter. The values obtained for the combination filter according to the present invention were T (0.3 μm)≧90% and T (0.1 μm)≧60%. When using the standard filter, T (0.3 μm) was definitely below 70% and T (0.1 μm) was even below 50%. It should be noted here that the improved particle separation achieved by the combination filter (diesel filter) according to the present invention not only results in a definite reduction in odor in the case of diesel odor but also results in a considerable reduction in the health hazard due to diesel soot particles. Diesel soot particles are regarded as a possible cause of adverse health effects due to the respirable particle size (PM 2.5=particles smaller than 2.5 μm).

What is claimed is:

1. A filter system, comprising at least one particle-filtering area and at least one chemical filter area, the chemical filter area including an activated carbon filter, wherein the particle-filtering area has a filter efficiency of T (0.3 μm)≧90%, when measured according to DIN 71460/1 @ 300 m³/h using AC fine test dust, and of T (0.1 μm)≧60%, when measured according to DIN 71460 @ 300 m³/h using NaCl as the test aerosol.

2. The filter system as recited in claim 1, wherein the activated carbon is impregnated activated carbon, said impregnated activated carbon providing an increase in the adsorption of acidic gases when compared with unimpregnated activated carbon.

3. The filter system as recited in claim 1, wherein the filter is a combination filter.

4. The filter system as recited in claim 1, wherein the particle-filtering area comprises a nonwoven filter.

5. The filter system as recited in claim 1, wherein the chemical filter area comprises a nonwoven filter.

6. The filter system as recited in claim 4, wherein the chemical filter area comprises a nonwoven filter.

7. The filter system as recited in claim 1, wherein the filter is a filter for filtering fresh air supplied to an interior fo a motor vehicle.

8. The filter system as recited in claim 4, wherein the nonwoven filter is made of microfibers.

9. The filter system as recited in claim 5,wherein the nonwoven filter is made of microfibers.

10. The filter system as recited in claim 4 wherein the nonwoven filter includes areas having an electrostatic charge.

11. The filter system as recited in claim 5,wherein the nonwoven filter includes areas having an electrostatic charge.
